(19) United States
(12) Patent Application Publication
(10) Pub. No.: US 2023/0354768 A1
(43) Pub. Date: Nov. 9, 2023

(54) Livestock Restraining Device

(71) Applicant: Luke Sullivan, Orange, TX (US)

(72) Inventor: Luke Sullivan, Orange, TX (US)

(21) Appl. No.: 18/313,044

(22) Filed: May 5, 2023

Related U.S. Application Data
(60) Provisional application No. 63/338,659, filed on May 5, 2022.

(51) Int. Cl. A01K 1/00

(52) U.S. Cl. CPC A01K 1/0017

(57) ABSTRACT

An improved livestock restraining device comprising a mounting component connected to an extending arm assembly to prevent an animal from bucking while situated within a chute. The improved livestock restraining device comprises a buck arm frame assembly and a mounting frame assembly. The buck arm is intended to be engaged across the hips and/or back of the animal to reduce the chance or opportunities for the animal to rear-up, kick, or buck as the rider is mounting, sitting, or preparing for a rodeo event. The improved livestock restraining device can help prevent injury to the rider, animal, and attendant assisting the rider and animal.

### CROSS-REFERENCE TO RELATED APPLICATIONS

This application claims the benefit of priority to U.S. Provisional Pat. Application 63/338,659, filed May 5, 2022, the contents which thereof are incorporated herein by reference.

### STATEMENT REGARDING FEDERALLY SPONSORED RESEARCH

Not applicable.

### BACKGROUND

The present invention generally relates to an improved livestock restraining device.

The improved livestock restraining device is a bucking chute metal restraining device. The device is designed and built to prevent injuries to bucking livestock, the rider, and assistants or bystanders while the animal is in a bucking chute. The device may attach or mount to the inside of the bucking chute and allow for a bar or brace to be extended across the animal’s hips and/or lower back to prevent the animal from bucking in the chute while the rider is mounting the animal or after the rider has mounted. This helps prevent injury to both the rider and the animal. It also reduces or prevents the animal from bucking in the chute prior to the chute opening and wasting energy or coming out of the chute backwards or turning around. This also cuts down on the time it takes the rider to prepare to ride and unnecessary contact by the handlers or assistant that may need to reach their arms or hands into the bucking chute.

Bull riding is considered one of the most dangerous rodeo sports having an incidence of injury reportedly at 32.2 injuries per 1000 competitor-exposures. See Downey, Daniel J. (2007) Rodeo Injuries and Prevention, Current Sports Medicine Reports. 6:328-332. Each ride and re-ride results in additional competitor exposure, which increases the chances of the rider, animal, or assistant/bystanders being injured. See Butterwick, Dale J. (2003) Bull Riding Injuries in Professional Rodeo, The Physician and Sports Medicine, Vol. 31, No. 6. 37-41. While the riders have taken efforts to protect themselves through the use of helmets and protective vests, there are further efforts that can be made to protect the riders, animals, and assistants/bystanders from incidents caused by the animal bucking while in the chute, such as the novel invention described and claimed herein.

There is also a need to protect the animals and reduce the opportunity for incidents or injuries while the animal is in the chute. Rodeo events can be stressful to the animal. Goldhawk C. Bond G, Grandin T, Pajor E (2016) Behaviour of bucking bulls prior to rodeo performances and relation to rodeo and human activities. Applied Animal Behaviour Science 181:63-69. Studies have shown that bucking bulls more often experienced muscle and bone injuries than bulls not used for bucking events. Smith J. Angelos JA, Chigerwe M (2017) Disorders of performance-age bucking bulls. Journal of American Veterinary Medical Association 250:1302-1307. The present invention and its various embodiments help to reduce the opportunities for injury to not just the rider, but the livestock as well. The present invention and its embodiments may reduce or eliminate the opportunities for the livestock to rear-up, kick, or buck while in the chute or reduce the ability of the animal to rear-up or out of the chute.

### SUMMARY

In some embodiments, the present invention is a metal bar apparatus that is mounted to the inside of a bucking chute to prevent livestock from bucking in the chute which can reduce the chance of injuries to the rider, animal, and attendants.

There is a particular need for an improved livestock restraining device within the rodeo and horse and bull rider community and industry. When horses or bulls are enclosed within a chute, the chutes are generally sized to minimize forward, backward, and lateral movement of the animal in the chute. This allows the rider to climb on to the animal and secure their positioning for the rodeo event. The time that the rider is situated on to or in the process of getting onto the animal while the animal is pinned in the chute is critical for the safety of the rider. This is a time where the rider could have their leg crushed against the side wall of the chute or be bucked or thrown off by the animal. Present chutes only account for movement by the animal lateral to the ground surface it is positioned on. Present chutes do not account, minimize, or prevent vertical mobility of the animal in the chute. Applicant’s revolutionary improved animal restraining device is designed and achieves a reduction in vertical movement by the animal while situated in the chute.

Some embodiments of the livestock restraining device comprise a buck arm frame assembly comprising a buck arm arrester rotatably joined to said buck arm frame assembly; a mounting frame assembly, wherein said mounting frame assembly comprises a first and second mounting frame member and one or more cross members, wherein said one or more cross members laterally joins the first and second mounting frame members to each other, said first and second mounting frame members further comprise a first and second guide channel for receiving said buck arm frame assembly; a plurality of mounting clips joined to said mounting frame.

Some embodiments of the livestock restraining device further comprise said plurality of mounting clips comprises one or more mounting clips that are slidably attached to said mounting frame assembly via one or more guide brackets.

Some embodiments of the livestock restraining device comprise said first and second mounting frame members further comprise one or more detents or holes formed on a surface; said buck arm frame assembly further comprises one or more locking pins that slidably engage with one or more brackets fixedly attached to said buck arm frame assembly. Some embodiments of the livestock restraining device further comprise said locking pins moveably engage with said one or more detents or holes formed on a surface. Some embodiments of the livestock restraining device further comprise said plurality of mounting clips further comprise one or more springs disposed along a length of said mounting clips.

Some embodiments of the livestock restraining device comprise a mounting frame assembly; a buck arm assembly comprising a buck arm arrester, a quick release handle, and a plurality of quick release arms, said plurality of quick release arms being pivotally joined at a medial point and operatively joined to said buck arm arrester and said quick release handle, whereby applying a rotational force to said quick release handle causes said plurality of quick release arms to extend away from said buck arm assembly, thereby extending said buck arm arrester away from said mounting frame assembly.

Some embodiments of the livestock restraining device further comprise wherein applying an opposite rotational force to said quick release handle causes said plurality of quick release arms to retract into said buck arm assembly, thereby retracting said buck arm arrester toward said mounting frame assembly. Some embodiments of the livestock restraining device further comprise said buck arm arrester is rotationally joined to said buck arm assembly. Some embodiments of the livestock restraining device further comprise said mounting frame assembly further comprises one or more guide channels for receiving said buck arm assembly. Some embodiments of the livestock restraining device further comprise wherein said mounting frame assembly further comprises one or more detents or holes formed on a surface of a first and second frame member, whereby a buck tube can traverse said one or more detents or holes to secure said buck arm assembly to said mounting frame assembly. Some embodiments of the livestock restraining device further comprise said buck arm assembly further comprises a shroud for receiving a distal end of said buck arm arrester when said buck arm arrester is in a retracted position. Some embodiments of the livestock restraining device further comprise said plurality of quick release arms when fully extended enter a locked position whereby said buck arm arrester in the extended position remains in a locked positioned.

Some embodiments of the livestock restraining device for securing a livestock in a chute comprise a buck arm arrester; a mounting frame assembly comprising a first mounting frame member, a second mounting frame member, and one or more cross members; and a plurality of mounting clips, wherein one or more of said plurality of mounting clips are fixedly attached to said mounting frame assembly and wherein one or more of said plurality of mounting clips are slidably mounted to said mounting frame assembly. Some embodiments of the livestock restraining device further comprise said one or more of said plurality of mounting clips that are slidably mounted to said mounting frame assembly further comprise a length whereupon one or more springs are disposed, said one or more springs engage one or more spring brackets thereby applying tension to said plurality of mounting clips that are slidably mounted to said mounting frame assembly. Some embodiments of the livestock restraining device further comprise a quick release handle; a buck tube further comprising a detent or hole formed through or on a surface of said buck tube, wherein a distal end of said quick release handle engages with said detent or hole. Some embodiments of the livestock restraining device further comprise said quick release handle further comprises a length whereupon one or more springs are disposed, said one or more springs engage one or more quick release spring brackets thereby applying tension to said quick release handle. Some embodiments of the livestock restraining device further comprise said buck arm arrester is operatively joined to one or more springs to tension said buck arm arrester towards a retracted position. Some embodiments of the livestock restraining device further comprise when said buck arm arrester is in an extended position disengagement of said distal end of said quick release handle from said detent or hole formed through or on a surface of said buck tube causes said springs operatively joined to said buck arm arrester to rotate said buck arm arrester toward a retracted position.

Some embodiments of the livestock restraining device comprise said livestock restraining device is mounted to one or more tubular members of a chute.

### BRIEF DESCRIPTION OF THE DRAWINGS

For a more complete understanding of the present disclosure and the advantages thereof, reference is now made to the following descriptions to be taken in conjunction with the accompanying drawings describing specific embodiments of the disclosure, wherein:

FIG. 1 illustrates an isometric view of an embodiment a livestock restraining device.

FIG. 2 illustrates a side view of an embodiment of a livestock restraining device with a buck arm arrester in an engaged or extended position.

FIG. 3 illustrates a side view of an embodiment of a livestock restraining device having a buck arm arrester in a disengaged position.

FIG. 4 illustrates a top view of an embodiment of a livestock restraining device with a buck arm arrester in an engaged or extended position.

FIG. 5 illustrates an isometric view of a livestock restraining device as installed on a chute fence and with a buck arm arrester in an engaged or extended position.

FIG. 6 illustrates an isometric view of an alternative embodiment of a livestock restraining device with a buck arm arrester in an engaged or extended position.

FIG. 7 illustrates an alternative embodiment of a buck arm frame assembly of a livestock restraining device with a buck arm arrester in an engaged or extended position.

FIG. 8 illustrates an alternative embodiment of a mounting frame assembly of a livestock restraining device.

FIG. 9 illustrates an alternative embodiment of the livestock restraining device with the buck arm arrester in an engaged or extended position.

### DETAILED DESCRIPTION

One or more illustrative embodiments incorporating the invention disclosed herein are presented below. The inventor has created a revolutionary and novel livestock restraining device with the goal to improve livestock, rider, and bystander health and safety at rodeo events. Other applications of the present invention can be to secure livestock in chutes during feeding, medical care, and cleaning activities.

In the following description, certain details are set forth such as specific quantities, sizes, etc. to provide a thorough understanding of the present embodiments disclosed herein. However, it will be evident to those of ordinary skill in the art that the present disclosure may be practiced without such specific details. In many cases, details concerning such considerations and the like have been omitted inasmuch as such details are not necessary to obtain a complete understanding of the present disclosure and are within the skills of persons of ordinary skill in the relevant art.

Referring to the drawings in general, it will be understood that the illustrations are for the purpose of describing embodiments of the disclosure and are not intended to be limiting thereto. Drawings are not necessarily to scale, and arrangements of specific units in the drawings can vary.

While most of the terms used herein will be recognizable to those of ordinary skill in the art, it should be understood, however, that when not explicitly defined, terms should be interpreted as adopting a meaning presently accepted by those of ordinary skill in the art. In cases where the construction of a term would render it meaningless, or essentially meaningless, the definition should be taken from Webster’s Dictionary 2023. Definitions and/or interpretations should not be incorporated from other patent applications, patents, or publications, related or not, unless specifically stated in this specification, or if the incorporation is necessary for maintaining validity.

While preferred embodiments have been shown, and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied.

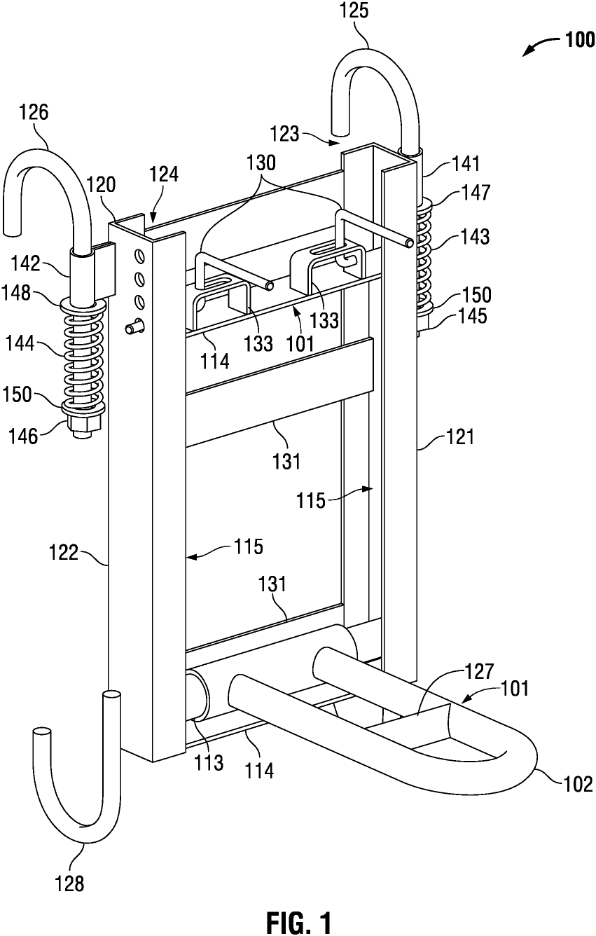

FIG. 1 illustrates an isometric view of an embodiment of a livestock restraining device 100. Some embodiments of the livestock restraining device 100 are comprised of two major components: buck arm frame assembly 101 and mounting frame assembly 120. In some embodiments, the buck arm frame assembly 101 is comprised of a buck arm arrester 102 which may be fixedly attached or rotatably attached to buck arm tube 113. In some embodiments, the mounting frame assembly 120 comprises a first mounting member 121 and a second mounting frame member 122, a first guide channel 123, and a second guide channel 124, cross member 131, and mounting clips 125, 126, 127, and 128 (partially obscured in FIG. 1 by buck arm arrester 102). It should be appreciated that while the term “mounting clip” is used herein, the term should be considered interchangeable with mounting hook, mounting bracket, or other manner of attaching a device to a tubular member known in the art while not deviating the present disclosure and teaching. As shown in the example embodiment of FIG. 1, mounting clips 127 and 128 may be fixedly attached to the first and second mounting frame members 121 and 122. While mounting clips 125 and 126 are movable attached to the first and second mounting frame members 121 and 122 via guide brackets 141 and 142. The mounting clips 125 and 126 may include a length wherein said length extends through said guide brackets 141 and 142. The mounting clips 125 and 126 may comprise one or more springs 143 and 144 for tensioning the mounting clips. The mounting clips at a distal end may include washers 150 or a nut 145 and 146, or other kind of end cap known in the art, for the springs 143 and 144 to tension against. In some embodiments, mounting clips 125 and 126 are engaged to a tubular railing of a chute wall or fence. In some embodiments, after mounting clips 125 and 126 are engaged, the user may exert a downward force or pull down on the livestock restraining device 100 causing the first and second mounting springs 143 and 144 to compress against spring brackets 141 and 142, or alternatively washers 147 and 148, and allowing mounting clips 127 and 128 to extend beyond a second tubular railing of a chute wall or fence relatively positioned below the first tubular railing. The livestock restraining device 100 may then be positioned against a plurality of tubular members of the chute wall or fence and once the user releases tension from the first and second mounting springs 143 and 144, the mounting clips 127 and 128 may engage the second tubular railing of the chute wall or fence thereby securing the livestock restraining device 100 to the plurality of tubular members of the chute wall or fence.

In some embodiments, the buck arm frame assembly 101 comprises a plurality of cross members 114, of which may include the buck arm tube 113, and a plurality of buck arm frame members 115. The buck arm frame assembly 101, in some embodiments, may allow for slidable engagement with the mounting frame assembly 120 via sliding the buck arm frame assembly into the first and second guide channels 123 and 124. In some embodiments, the buck arm frame assembly 101 may allow for vertical height adjustment via locking pins 130 and engagement of a distal end of said locking pins 130 with one or more detents or holes 137 formed on a surface of the first and second mounting frame members 121 and 122 respectively. The locking pins 130 may be slidably mounted to the buck arm frame assembly 101 via one or more brackets 133 thereby allowing a user to adjust the height of the buck arm frame assembly 101 and the buck arm arrester 102 by engaging the various detents or holes 137 with the locking pins 130 to accommodate various heights or sizes of livestock to be restrained. It should be appreciated that the locking pins 130 and detent or holes 137 may be achieved in different forms than those depicted in FIG. 1 without straying from the disclosure and teachings of the present invention. Other embodiments may only include a single set of holes or detents to lock the buck arm frame assembly 101 into a single position or height relative to the mounting frame assembly 120. It should be appreciated that in some embodiments the mounting clips 125, 126, 127, and 128 may be fixedly attached to the mounting frame assembly to allow for permanent installation to one or more tubular members of a chute wall. Preferably, mounting clips include at least a top pair of mounting clips that are moveably attached to the mounting frame assembly whether through the use of springs tensioners and a fixed, bottom pair of mounting clips to allow for easy installation and removal of the mounting frame assembly. It should be appreciated that the bottom pair of mounting clips may be moveably attached to the mounting frame assembly, while the top pair of mounting clips are fixedly attached to the mounting frame assembly. Some embodiments may optionally include moveably attached mounting clips on both the top and bottom of the mounting frame assembly. In some embodiments, the mounting clips 125 and 126 may be secured in position to prevent removal of the mounting frame assembly 120 by tightening nuts 145 and 146 which may be threadedly engaged to a distal end of mounting clips 125 and 126. In some embodiments, mounting clips 125 and 126 may include a pin and detent or hole arrangement whereby a pin is inserted into a detent or hole formed at a medial point along the length of the mounting clip to engage against a surface of spring bracket 141 and 142.

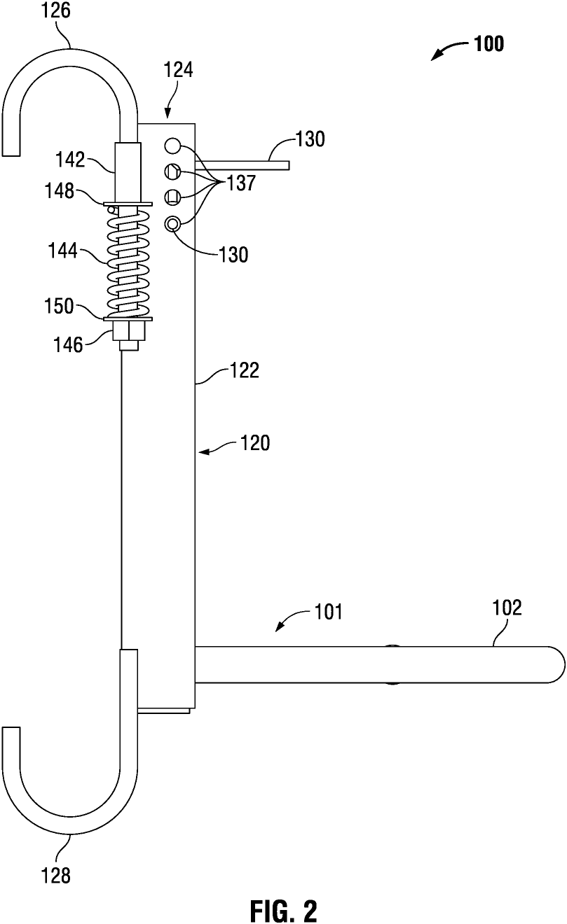

FIG. 2 illustrates a side view of an embodiment of a livestock restraining device 100 comprising a mounting frame assembly 120 and buck arm frame assembly 101 wherein the buck arm arrester 102 is in an engaged or extended position. Mounting frame assembly 120 includes mounting frame member 122 and mounting clips 126 and 128. Mounting clip 128 is fixedly attached to a lower portion of mounting frame member 122. Mounting clip 126 is moveably attached to mounting frame member 122 via slidable engagement with spring bracket 142. A length of mounting clip 126 may include a washer 148 and spring 144 situated between the spring bracket 142 and a distal end of mounting clip 126. The distal end of mounting clip 126 may be terminated with a nut 126 and, optionally, washer 150. It should be appreciated that when terminated with a nut 126 that is threadably engaged to mounting clip 126, the spring can be tensioned or have tension released by tightening or loosening nut 126. In other embodiments, nut 126 may be fixedly attached to the distal end to prevent movement or slippage. It should be appreciated that other ways of terminating the end of the length of mounting clip 126 to allow for the same functionality and result may be known in the art. The buck arm frame assembly 101, in some embodiments, may allow for slidable engagement with the mounting frame assembly 120 via sliding the buck arm frame assembly into the first and second guide channels 123 and 124. In some embodiments, the buck arm frame assembly 101 may allow for vertical height adjustment via locking pins 130 and engagement of a distal end of said locking pins 130 with one or more detents or holes 137 formed on a surface of the first and second mounting frame members 121 and 122 respectively. The locking pins 130 may be slidably mounted to the buck arm frame assembly 101 via one or more brackets 133 thereby allowing a user to adjust the height of the buck arm frame assembly 101 and the buck arm arrester 102 by engaging the various detents or holes 137 with the locking pins 130 to accommodate various heights or sizes of livestock to be restrained. It should be appreciated that the locking pins 130 and detent or holes 137 may be achieved in different forms than those depicted in FIG. 1 without straying from the disclosure and teachings of the present invention. Other embodiments may only include a single set of holes or detents to lock the buck arm frame assembly 101 into a single position or height relative to the mounting frame assembly 120. It should be appreciated that in some embodiments the mounting clips 125, 126, 127, and 128 may be fixedly attached to the mounting frame assembly to allow for permanent installation to one or more tubular members of a chute wall. Preferably, mounting clips include at least a top pair of mounting clips that are moveably attached to the mounting frame assembly whether through the use of springs tensioners and a fixed, bottom pair of mounting clips to allow for easy installation and removal of the mounting frame assembly. It should be appreciated that the bottom pair of mounting clips may be moveably attached to the mounting frame assembly, while the top pair of mounting clips are fixedly attached to the mounting frame assembly. Some embodiments may optionally include moveably attached mounting clips on both the top and bottom of the mounting frame assembly. In some embodiments, the mounting clips 125 and 126 may be secured in position to prevent removal of the mounting frame assembly 120 by tightening nuts 145 and 146 which may be threadedly engaged to a distal end of mounting clips 125 and 126. In some embodiments, mounting clips 125 and 126 may include a pin and detent or hole arrangement whereby a pin is inserted into a detent or hole formed at a medial point along the length of the mounting clip to engage against a surface of spring bracket 141 and 142.

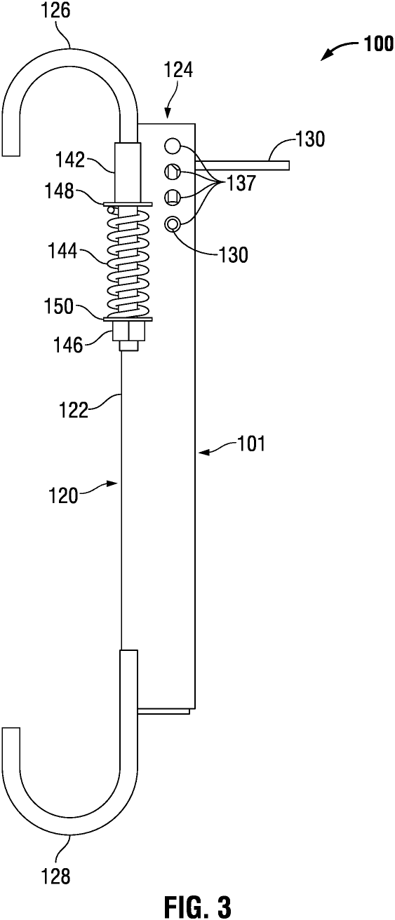

FIG. 3 illustrates a side view of an embodiment of a livestock restraining device 100 where the buck arm arrester 102 of the buck arm frame assembly 101 is in a disengaged position. When in the disengaged or retracted position, buck arm arrester 102 is positioned between the first mounting frame member 124 and second mounting frame member 123 (not shown in FIG. 3) in a substantially vertical position or in parallel with the mounting frame members 123 and 124. Mounting frame assembly 120 includes mounting frame member 122 and mounting clips 126 and 128. Mounting clip 128 is fixedly attached to a lower portion of mounting frame member 122. Mounting clip 126 is moveably attached to mounting frame member 122 via slidable engagement with spring bracket 142. A length of mounting clip 126 may include a washer 148 and spring 144 situated between the spring bracket 142 and a distal end of mounting clip 126. The distal end of mounting clip 126 may be terminated with a nut 126 and, optionally, washer 150. It should be appreciated that when terminated with a nut 126 that is threadably engaged to mounting clip 126, the spring can be tensioned or have tension released by tightening or loosening nut 126. In other embodiments, nut 126 may be fixedly attached to the distal end to prevent movement. It should be appreciated that other ways of terminating the end of a length of mounting clip 126 to allow for the same functionality and result may be known in the art. The buck arm frame assembly 101, in some embodiments, may allow for slidable engagement with the mounting frame assembly 120 via sliding the buck arm frame assembly into the first and second guide channels 123 and 124. In some embodiments, the buck arm frame assembly 101 may allow for vertical height adjustment via locking pins 130 and engagement of a distal end of said locking pins 130 with one or more detents or holes 137 formed on a surface of the first and second mounting frame members 121 and 122 respectively. The locking pins 130 may be slidably mounted to the buck arm frame assembly 101 via one or more brackets 133 thereby allowing a user to adjust the height of the buck arm frame assembly 101 and the buck arm arrester 102 by engaging the various detents or holes 137 with the locking pins 130 to accommodate various heights or sizes of livestock to be restrained. It should be appreciated that the locking pins 130 and detent or holes 137 may be achieved in different forms than those depicted in FIG. 1 without straying from the disclosure and teachings of the present invention. Other embodiments may only include a single set of holes or detents to lock the buck arm frame assembly 101 into a single position or height relative to the mounting frame assembly 120. It should be appreciated that in some embodiments the mounting clips 125, 126, 127, and 128 may be fixedly attached to the mounting frame assembly to allow for permanent installation to one or more tubular members of a chute wall. Preferably, mounting clips include at least a top pair of mounting clips that are moveably attached to the mounting frame assembly whether through the use of springs tensioners and a fixed, bottom pair of mounting clips to allow for easy installation and removal of the mounting frame assembly. It should be appreciated that the bottom pair of mounting clips may be moveably attached to the mounting frame assembly, while the top pair of mounting clips are fixedly attached to the mounting frame assembly. Some embodiments may optionally include moveably attached mounting clips on both the top and bottom of the mounting frame assembly. In some embodiments, the mounting clips 125 and 126 may be secured in position to prevent removal of the mounting frame assembly 120 by tightening nuts 145 and 146 which may be threadedly engaged to a distal end of mounting clips 125 and 126. In some embodiments, mounting clips 125 and 126 may include a pin and detent or hole arrangement whereby a pin is inserted into a detent or hole formed at a medial point along the length of the mounting clip to engage against a surface of spring bracket 141 and 142.

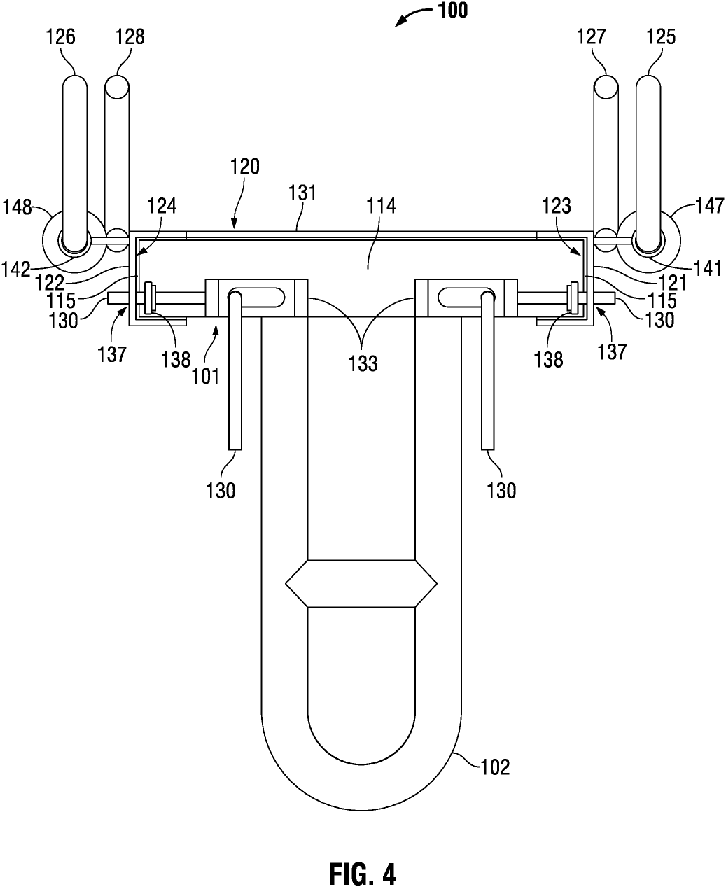

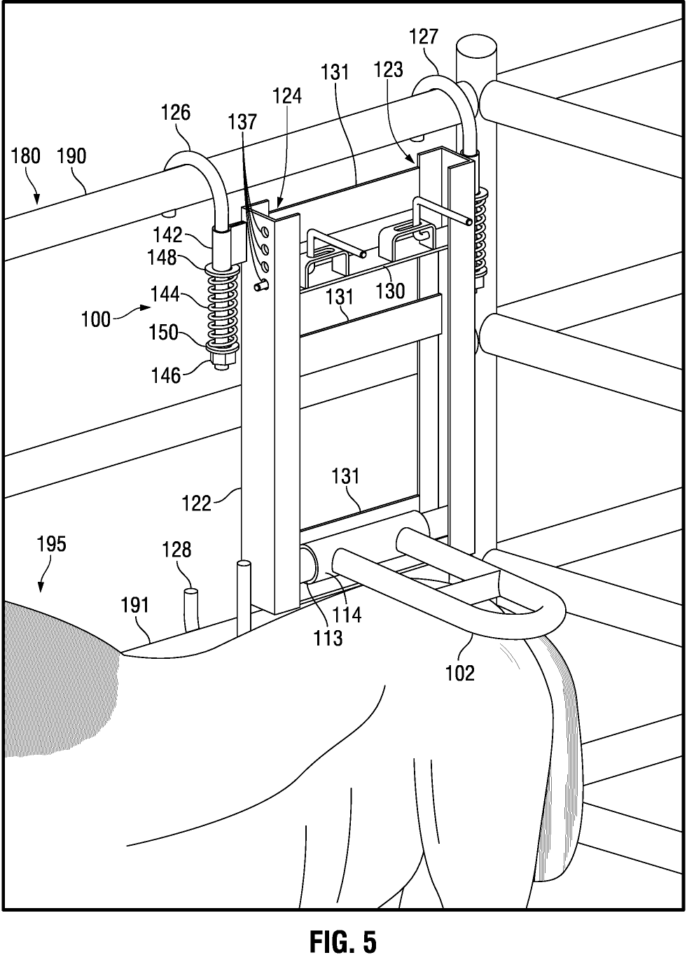

FIG. 4 illustrates a top view of an embodiment of a livestock restraining device 100 with a buck arm arrester 102 in an engaged or extended position. Some embodiments of the livestock restraining device 100 are comprised of two major components: buck arm frame assembly 101 and mounting frame assembly 120. In some embodiments, the buck arm frame assembly 101 is comprised of a buck arm arrester 102 which may be fixedly attached or rotatably attached to buck arm tube 113 (see FIG. 1). In some embodiments, the mounting frame assembly 120 comprises a first mounting member 121 and a second mounting frame member 122, a first guide channel 123, and a second guide channel 124, cross member 131, and mounting clips 125, 126, 127, and 128. Mounting clips 127 and 128 may be fixedly attached to the first and second mounting frame members 121 and 122. While mounting clips 125 and 126 are movable attached to the first and second mounting frame members 121 and 122 via guide brackets 141 and 142. The mounting clips 125 and 126 may include a length wherein said length extends through said guide brackets 141 and 142. The mounting clips 125 and 126 may comprise one or more springs 143 and 144 for tensioning the mounting clips (see FIGS. 1, 2, 3). The mounting clips at a distal end may include a nut 145 and 146, or other kind of end cap known in the art, for the springs 143 and 144 to tension against. In some embodiments, mounting clips 125 and 126 are engaged to a tubular railing of a chute wall or fence. In some embodiments, after mounting clips 125 and 126 are engaged, the user may exert a downward force or pull down on the livestock restraining device 100 and/or the mounting frame assembly causing the first and second mounting springs 143 and 144 to compress against spring brackets 141 and 142, or alternatively washers 147 and 148, and allowing mounting clips 127 and 128 to extend beyond a second tubular railing of a chute wall or fence relatively positioned below the first tubular railing, such as that shown in FIG. 5. The livestock restraining device 100 may then be positioned against a plurality of tubular members of the chute wall or fence and once the user releases tension from the first and second mounting springs 143 and 144, the mounting clips 127 and 128 may engage the second tubular railing of the chute wall or fence thereby securing the livestock restraining device 100 to the plurality of tubular members of the chute wall or fence. In some embodiments, the buck arm frame assembly 101 comprises a plurality of cross members 114, of which may include the buck arm tube 113, and a plurality of buck arm frame members 115. The buck arm frame assembly 101, in some embodiments, may allow for slidable engagement with the mounting frame assembly 120 via sliding the buck arm frame assembly into the first and second guide channels 123 and 124. In some embodiments, the buck arm frame assembly 101 may allow for vertical height adjustment via locking pins 130 and engagement of a distal end of said locking pins 130 with one or more detents or holes 137 formed on a surface of the first and second mounting frame members 121 and 122 respectively. The locking pins 130 may be slidably mounted to the buck arm frame assembly 101 via one or more brackets 133 thereby allowing a user to adjust the height of the buck arm frame assembly 101 and the buck arm arrester 102 by engaging the various detents or holes 137 with the locking pins 130 to accommodate various heights or sizes of livestock to be restrained. It should be appreciated that the locking pins 130 and detent or holes 137 may be achieved in different forms than those depicted in FIG. 4 without straying from the disclosure and teachings of the present invention. In some embodiments, the locking pins 130 may comprise a stopper, nut, or other device 138 fixedly attached to the locking pin to prevent overtravel or inadvertent disengagement of the locking pin. Other embodiments may only include a single set of holes or detents to lock the buck arm frame assembly 101 into a single position or height relative to the mounting frame assembly 120. It should be appreciated that in some embodiments the mounting clips 125, 126, 127, and 128 may be fixedly attached to the mounting frame assembly to allow for permanent installation to one or more tubular members of a chute wall. Preferably, mounting clips include at least a top pair of mounting clips that are moveably attached to the mounting frame assembly whether through the use of springs tensioners and a fixed, bottom pair of mounting clips to allow for easy installation and removal of the mounting frame assembly. It should be appreciated that the bottom pair of mounting clips may be moveably attached to the mounting frame assembly, while the top pair of mounting clips are fixedly attached to the mounting frame assembly. Some embodiments may optionally include moveably attached mounting clips on both the top and bottom of the mounting frame assembly. In some embodiments, the mounting clips 125 and 126 may be secured in position to prevent removal of the mounting frame assembly 120 by tightening nuts 145 and 146 which may be threadedly engaged to a distal end of mounting clips 125 and 126. In some embodiments, mounting clips 125 and 126 may include a pin and detent or hole arrangement whereby a pin is inserted into a detent or hole formed at a medial point along the length of the mounting clip to engage against a surface of spring bracket 141 and 142.

FIG. 5 illustrates an isometric view of a livestock restraining device 100 as installed on a chute fence 180 and with a buck arm arrester 102 in an engaged or extended position thereby restraining livestock 195. When the buck arm arrester 102 is engaged or extended over the livestock 195, the buck arm arrester 102 and livestock restraining device 100 prevents or reduces the opportunities for the livestock to rear-up, kick, or buck while in the chute. As discussed above, this is advantageous to the intended rider of the livestock as well as those assisting the rider and the livestock. The buck arm arrester can prevent serious injury that would otherwise occur when the livestock 195 is being shepherded into the chute, as the rider mounts the livestock, or while the rider is seated on the livestock. The prevention or minimalization of bucking opportunities while the livestock is in the chute is paramount to the participants’ safety as well as those persons assisting the participants and livestock. As shown in FIG. 5, chute fence 180 may comprise one or more tubular members 190 and 191 to which the mounting clips 125, 126, 127, and 128 may attach the livestock restraining device 100. Some embodiments of the livestock restraining device 100 are comprised of two major components: buck arm frame assembly 101 and mounting frame assembly 120. In some embodiments, the buck arm frame assembly 101 is comprised of a buck arm arrester 102 which may be fixedly attached or rotatably attached to buck arm tube 113. In some embodiments, the mounting frame assembly 120 comprises a first mounting member 121 and a second mounting frame member 122, a first guide channel 123, and a second guide channel 124, cross member 131, and mounting clips 125, 126, 127, and 128 (obscured in FIG. 5 by livestock 195). As shown in the example embodiment of FIG. 5, mounting clips 127 and 128 may be fixedly attached to the first and second mounting frame members 121 and 122. While mounting clips 125 and 126 are movable attached to the first and second mounting frame members 121 and 122 via guide brackets 141 and 142. The mounting clips 125 and 126 may include a length wherein said length extends through said guide brackets 141 and 142. The mounting clips 125 and 126 may comprise one or more springs 143 and 144 for tensioning the mounting clips. The mounting clips at a distal end may include a nut 145 and 146, or other kind of end cap known in the art, for the springs 143 and 144 to tension against. In some embodiments, mounting clips 125 and 126 are engaged to a tubular railing 190 and 191 of a chute wall or fence 180. In some embodiments, after mounting clips 125 and 126 are engaged, the user may exert a downward force or pull down on the livestock restraining device 100 causing the first and second mounting springs 143 and 144 to compress against spring brackets 141 and 142, or alternatively washers 147 and 148, and allowing mounting clips 127 and 128 to extend beyond a second tubular railing 191 of a chute wall or fence 180 relatively positioned below the first tubular railing 190. The livestock restraining device 100 may then be positioned against a plurality of tubular members 190 and 191 of the chute wall or fence 180 and once the user releases tension from the first and second mounting springs 143 and 144, the mounting clips 127 and 128 may engage the second tubular railing 191 of the chute wall or fence thereby securing the livestock restraining device 100 to the plurality of tubular members of the chute wall or fence 180.

In some embodiments, the buck arm frame assembly 101 comprises a plurality of cross members 114, of which may include the buck arm tube 113, and a plurality of buck arm frame members 115. The buck arm frame assembly 101, in some embodiments, may allow for slidable engagement with the mounting frame assembly 120 via sliding the buck arm frame assembly into the first and second guide channels 123 and 124. In some embodiments, the buck arm frame assembly 101 may allow for vertical height adjustment via locking pins 130 and engagement of a distal end of said locking pins 130 with one or more detents or holes 137 formed on a surface of the first and second mounting frame members 121 and 122 respectively. The locking pins 130 may be slidably mounted to the buck arm frame assembly 101 via one or more brackets 133 thereby allowing a user to adjust the height of the buck arm frame assembly 101 and the buck arm arrester 102 by engaging the various detents or holes 137 with the locking pins 130 to accommodate various heights or sizes of livestock to be restrained. It should be appreciated that the locking pins 130 and detent or holes 137 may be achieved in different forms than those depicted in FIG. 1 without straying from the disclosure and teachings of the present invention. Other embodiments may only include a single set of holes or detents to lock the buck arm frame assembly 101 into a single position or height relative to the mounting frame assembly 120. It should be appreciated that in some embodiments the mounting clips 125, 126, 127, and 128 may be fixedly attached to the mounting frame assembly to allow for permanent installation to one or more tubular members of a chute wall. Preferably, mounting clips include at least a top pair of mounting clips that are moveably attached to the mounting frame assembly whether through the use of springs tensioners and a fixed, bottom pair of mounting clips to allow for easy installation and removal of the mounting frame assembly. It should be appreciated that the bottom pair of mounting clips may be moveably attached to the mounting frame assembly, while the top pair of mounting clips are fixedly attached to the mounting frame assembly. Some embodiments may optionally include moveably attached mounting clips on both the top and bottom of the mounting frame assembly. In some embodiments, the mounting clips 125 and 126 may be secured in position to prevent removal of the mounting frame assembly 120 by tightening nuts 145 and 146 which may be threadedly engaged to a distal end of mounting clips 125 and 126. In some embodiments, mounting clips 125 and 126 may include a pin and detent or hole arrangement whereby a pin is inserted into a detent or hole formed at a medial point along the length of the mounting clip to engage against a surface of spring bracket 141 and 142.

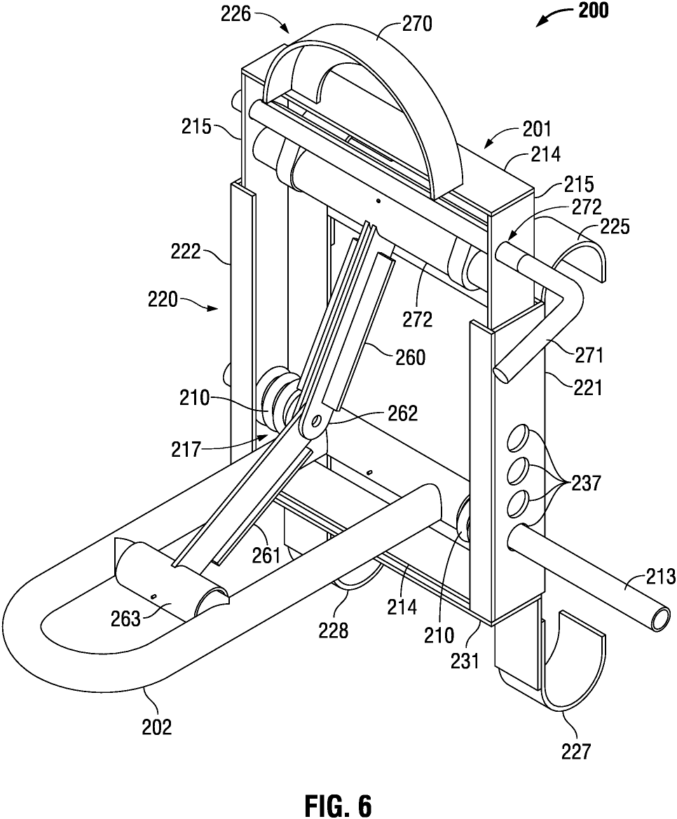

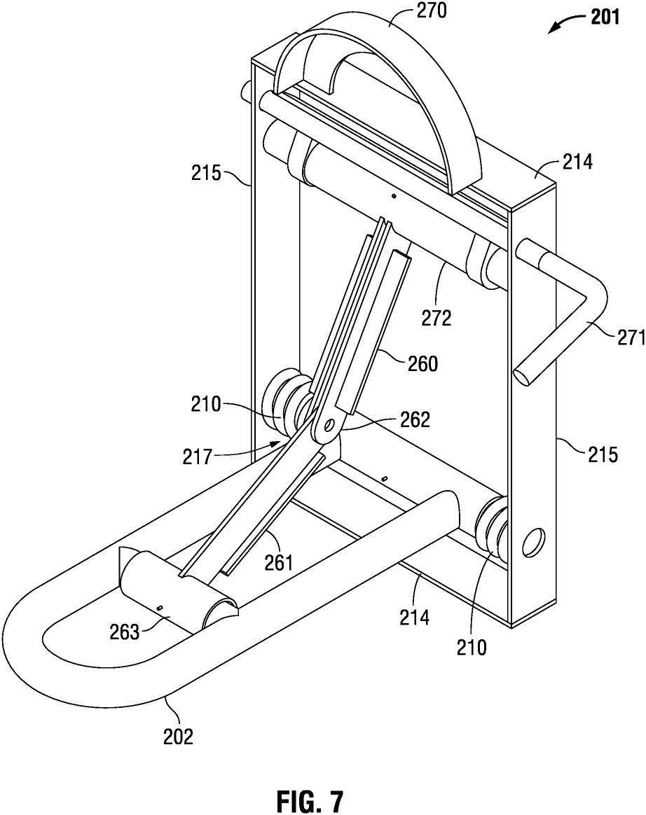

FIG. 6 illustrates an isometric view of an alternative embodiment of a livestock restraining device 200 comprising a mounting frame assembly 220 and buck arm assembly 201. The buck arm assembly 201 of FIG. 6 depicts a buck arm arrester 202 in an engaged or extended position. The buck arm assembly 201 includes a plurality of side frame members 215 and one or more cross members 214. In some embodiments the buck arm tube 213 may be one of the one or more cross members. The buck arm assembly includes one or more springs 210 for tensioning the buck arm arrester 202, the springs may be disposed on or around buck arm tube 213 and may be further disposed around a separate tubular member mounted to the buck arm frame assembly through which buck arm tube 213 traverses an internal cavity of the tubular member. The buck arm arrester 202 may be transitioned between an engaged or extended position, as shown in FIG. 6, and a retracted position wherein, the buck arm arrester 202 is in an elevated or substantially vertical position relative to the engaged or extended position. The buck arm frame assembly 201 further includes a shroud 270 in which a distal portion of the buck arm arrester 202 may be disposed when in the retracted position. Shroud 270 may also act as a carrying handle when the buck arm frame assembly 201 or the entire livestock restraining device 200 is desired to be moved from location to location. In some embodiments, the buck arm arrester pivots about buck arm tube 213 or other tubular member 217 mounted to the buck arm frame assembly 201. The buck arm arrester 202 in some embodiments is raised and lowered via quick release arms 260 and 261. The quick release arms 260 and 261 are operatively connected as a rotatable joint 262, such that when quick release handle 271 is rotated it causes rotation of quick release tubular member 272 which then causes quick release arm 260 to extend outwardly away from the buck frame assembly 201. The movement of the quick release handle 271 and quick release arm 260 also causes quick release arm 261 to extend up and away from the buck arm arrested via joint 262. The attachment portion 263 of quick release arm 261 may be rotatably engaged with a portion of the buck arm arrester 202. By applying a rotational force to quick release handle 271, the user may engage/extend or disengage/retract the buck arm arrester 202. In some embodiments, when the quick release handle 271 is rotated into the engaged/extended position, the buck arm assembly 201 and buck arm arrester will lock into place thereby preventing or minimizing the opportunity for a livestock to rear-up, kick, or buck while in a chute. In some embodiments, the quick release handle 271 may then be rotated in the opposite direction to disengage the lock and allow for the springs 210 to perform a quick retraction of the buck arm arrester 202 into the disengaged/retracted position thereby pulling quick release arms 260 and 261 back towards the buck arm assembly 201. In some embodiments, the quick release arms 260 and 261 may be designed or built in such a manner as to allow one to nest within or around the other, thereby allowing for a more compact assembly. Such compactness may be desired as some chutes are designed to be narrow and only large enough to hold the livestock without much room to move on either side of the livestock, but enough room to allow the rider’s legs to rest on either side of the livestock and/or allow for attendants to move in and about the chute. The mounting frame assembly 220, in some embodiments, may include mounting frame members 221 and 222 and one or more cross members 231. The mounting frame members 221 and 222 have formed on an interior surface of said frame members 221 and 222 guide channels 223 and 224 for receiving the buck arm assembly 201, shown in FIG. 7. The buck arm assembly 201 may be secured to the mounting frame assembly via buck tube 213 that traverses tubular member 217 of the buck arm assembly and through one or more detents or holes 237 formed on the surfaces of the mounting frame members 221 and 222. It should be appreciated that the one or more detents or holes 237 may allow for height adjustment of the buck arm assembly by selective placement of the buck arm assembly at different detents or holes 237 and secured into position via buck tube 213. The mounting frame assembly may further include mounting clips 225, 226, 227, and 228. In some embodiments, the mounting clips may be fixedly attached to the mounting frame assembly. In other embodiments, as described herein, one or more of the mounting clips may be moveable connected to the mounting frame members 221 and 222 or otherwise joined to the mounting frame assembly 220.

FIG. 7 illustrates an alternative embodiment of a buck arm frame assembly 201 of a livestock restraining device 200 with a buck arm arrester in an engaged or extended position. The buck arm assembly 201 of FIG. 7 depicts a buck arm arrester 202 in an engaged or extended position. The buck arm assembly 201 includes a plurality of side frame members 215 and one or more cross members 214. In some embodiments the buck arm tube 213 may be one of the one or more cross members. The buck arm assembly includes one or more springs 210 for tensioning the buck arm arrester 202, the springs may be disposed on or around buck arm tube 213 and may be further disposed around a separate tubular member mounted to the buck arm frame assembly through which buck arm tube 213 traverses an internal cavity of the tubular member. The buck arm arrester 202 may be transitioned between an engaged or extended position, as shown in FIG. 7, and a retracted position (see FIG. 3) wherein, the buck arm arrester 202 is in an elevated or substantially vertical position relative to the engaged or extended position. The buck arm frame assembly 201 further includes a shroud 270 in which a distal portion of the buck arm arrester 202 may be disposed when in the retracted position. Shroud 270 may also act as a carrying handle when the buck arm frame assembly 201 or the entire livestock restraining device 200 is desired to be moved from location to location. In some embodiments, the buck arm arrester pivots about buck arm tube 213 or other tubular member 217 mounted to the buck arm frame assembly 201. The buck arm arrester 202 in some embodiments is raised and lowered via quick release arms 260 and 261. The quick release arms 260 and 261 are operatively connected as a rotatable joint 262, such that when quick release handle 271 is rotated it causes rotation of quick release tubular member 272 which then causes quick release arm 260 to extend outwardly away from the buck frame assembly 201. The movement of the quick release handle 271 and quick release arm 260 also causes quick release arm 261 to extend up and away from the buck arm arrested via joint 262. The attachment portion 263 of quick release arm 261 may be rotatably engaged with a portion of the buck arm arrester 202. By applying a rotational force to quick release handle 271, the user may engage/extend or disengage/retract the buck arm arrester 202. In some embodiments, when the quick release handle 271 is rotated into the engaged/extended position, the buck arm assembly 201 and buck arm arrester will lock into place thereby preventing or minimizing the opportunity for a livestock to rear-up, kick, or buck while in a chute. In some embodiments, the quick release handle 271 may then be rotated in the opposite direction to disengage the lock and allow for the springs 210 to perform a quick retraction of the buck arm arrester 202 into the disengaged/retracted position thereby pulling quick release arms 260 and 261 back towards the buck arm assembly 201. In some embodiments, the quick release arms 260 and 261 may be designed or built in such a manner as to allow one to nest within or around the other, thereby allowing for a more compact assembly. Such compactness may be desired as some chutes are designed to be narrow and only large enough to hold the livestock without much room to move on either side of the livestock, but enough room to allow the rider’s legs to rest on either side of the livestock and/or allow for attendants to move in and about the chute.

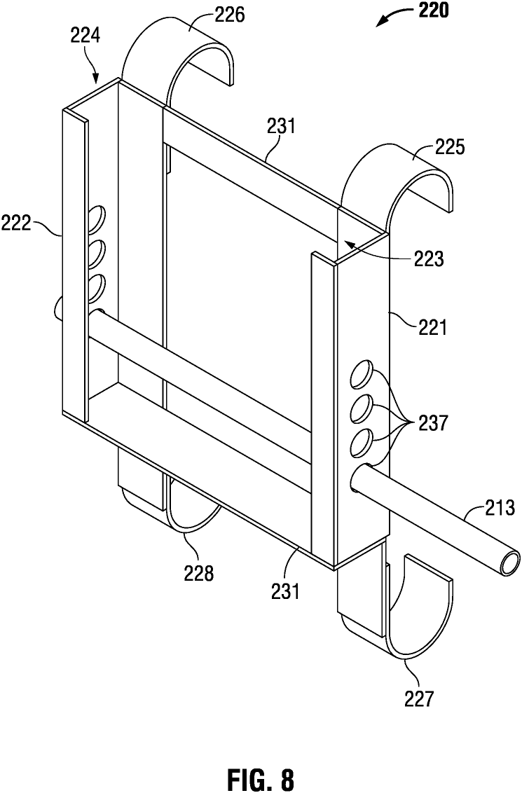

FIG. 8 illustrates an alternative embodiment of a mounting frame assembly 220 of a livestock restraining device 200. The mounting frame assembly 220, in some embodiments, may include mounting frame members 221 and 222 and one or more cross members 231. The mounting frame members 221 and 222 have formed on an interior surface of said frame members 221 and 222 guide channels 223 and 224 for receiving the buck arm assembly 201, shown in FIG. 7. The buck arm assembly 201 may be secured to the mounting frame assembly via buck tube 213 that traverses tubular member 217 of the buck arm assembly and through one or more detents or holes 237 formed on the surfaces of the mounting frame members 221 and 222. It should be appreciated that the one or more detents or holes 237 may allow for height adjustment of the buck arm assembly by selective placement of the buck arm assembly at different detents or holes 237 and secured into position via buck tube 213. The mounting frame assembly may further include mounting clips 225, 226, 227, and 228. In some embodiments, the mounting clips may be fixedly attached to the mounting frame assembly. In other embodiments, as described herein, one or more of the mounting clips may be moveably connected to the mounting frame members 221 and 222 or otherwise joined to the mounting frame assembly 220.

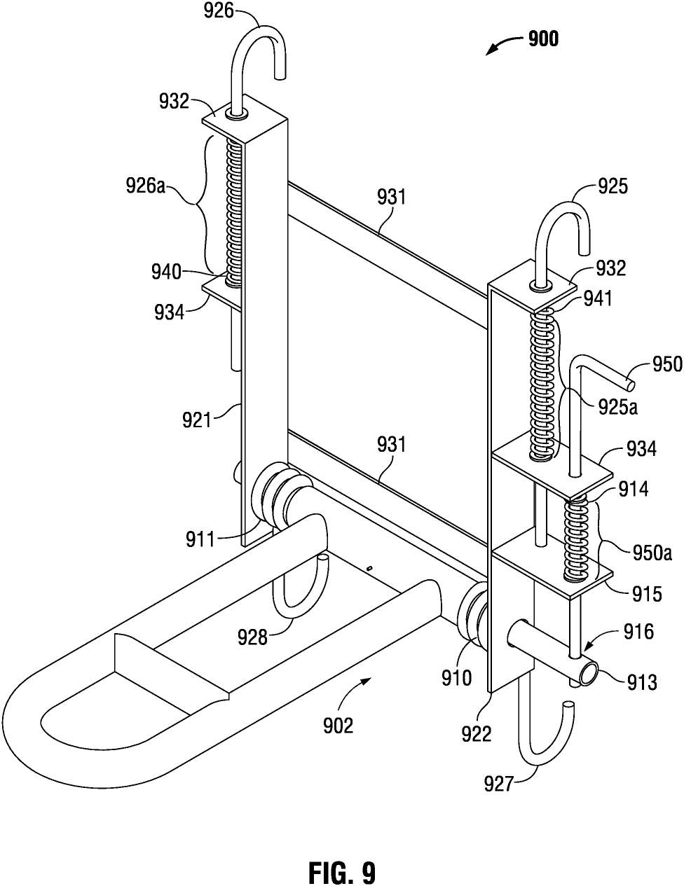

FIG. 9 illustrates an alternative embodiment of the livestock restraining device 900 with the buck arm arrester in an engaged or extended position. The livestock restraining device 900 is a single unit where the buck arm arrester 902 is attached to a mounting frame assembly 920. The mounting frame assembly 920 is comprised of a first mounting frame member 921, a second mounting frame member 922, and one or more cross members 931. Mounting clips 925 and 926 are moveably attached to an upper portion of the first mounting frame member 921 and second mounting frame member 922. Mounting clips 927 and 928 may be fixedly attached to a lower portion of one or both the first mounting frame member 921 and second mounting frame member 922. It should be understood that this arrangement can be reversed to allow the fixedly attached mounting clips to be positioned on an upper portion of the mounting frame members 921 and 922 and the moveably attached mounting clips to be positioned on a lower portion of the mounting frame members. In some embodiments, the mounting clips 925 and 926 include a length 925a and 926a that extends along the first and second mounting frame members 912 and 922. The length of mounting clips 925 and 926 may extend through a spring bracket 932 fixedly attached, such as by welding or cast as a single piece, to the first and second mounting frame members 921 and 922. In some embodiments, the length of mounting clips 925 and 926 may extend through a guide bracket 934. In some embodiments, the length of mounting clips 925 and 926 may comprise a spring tensioner 933. In some embodiments, the length of mounting clips 925 and 926 may extend through a first mounting spring 940 and second mounting spring 941, respectively. In some embodiments, mounting clips 925 and 926 are engaged to a tubular railing of a chute wall or fence. In some embodiments, after mounting clips 925 and 926 are engaged, the user may exert a downward force or pull down on the livestock restraining device 900 causing the first and second mounting springs 910 and 911 to compress against spring brackets 932 and allowing mounting clips 927 and 928 to extend beyond a second tubular railing of a chute wall or fence. The livestock restraining device 900 may then be positioned against the plurality of tubular members of the chute wall or fence and once the user releases tension from the first and second mounting springs 940 and 941, then the mounting clips 927 and 928 may engage the second tubular railing of the chute wall or fence thereby securing the livestock restraining device 900 to the tubular members of the chute wall or fence. The buck arm arrester 902 is rotatable about buck arm member 913. The buck arm arrester 902 may rotate into an extended or engaged position, such as that shown in FIG. 9. While in the engaged or extended position, the buck arm arrester 902 is tensioned via first spring 910 and second spring 911, wherein the buck arm arrester is tensioned to return to a disengaged or retracted position, not shown. When in the disengaged or retracted position, buck arm arrester is positioned between the first mounting frame member 921 and second mounting frame member 922 in a substantially vertical position or in parallel with the mounting frame members. Buck arm member 913 may further include a detent or hole 916 on or through one or more surfaces of the buck arm member, wherein a quick release handle 950 having a length 950a. The quick release handle 950, in some embodiments, may extend through guide bracket 934 and quick release guide bracket 915. Quick release handle 950 may further comprise quick release spring 914 along the length 950a of the quick release handle. The quick release spring 914 may be situated between guide bracket 934 and quick release guide bracket 915. To operate the buck arm arrester 902, the user may pull down and away from the mounting frame assembly 920 to place the buck arm arrester into the engaged or extended position thereby tensioning the first and second springs 910 and 911. The user may then engage a distal end of the quick release handle 950 with or into quick release detent or hole 916 thereby locking the buck arm arrester 902 into the engaged or extended position. When locked and in the engaged and extended position, the buck arm arrester 902 prevents or reduces the ability for the restrained livestock to buck or jump within the chute or pin. To release the tension of springs 910 and 911, the user may retract or pull quick release handle 950 to disengage from quick release detent or hole 916, which will cause the buck arm arrester 902 to rotate about buck arm member 913 and move into a disengaged or retracted position substantially parallel, or vertical, with first mounting frame member 921 and second frame mounting member 922.

While preferred embodiments have been shown and described, modifications thereof can be made by one skilled in the art without departing from the scope or teaching herein. The embodiments described herein are exemplary only and are not limiting. Many variations and modifications of the system and apparatus are possible and will become apparent to those skilled in the art once the above disclosure is fully appreciated. For example, the relative dimensions of various parts, the materials from which the various parts are made, and other parameters can be varied. Further, it should be appreciated that the disclosure and teachings of the several embodiments described herein may be used interchangeably to achieve different embodiments not explicitly depicted. Accordingly, it is intended that the following claims be interpreted to embrace all such variations and modifications.

What is claimed is the following:

1. A livestock restraining device comprising:
a buck arm frame assembly comprising a buck arm arrester rotatably joined to said buck arm frame assembly;
a mounting frame assembly, wherein said mounting frame assembly comprises a first and second mounting frame member and one or more cross members, wherein said one or more cross members laterally joins the first and second mounting frame members to each other, said first and second mounting frame members further comprise a first and second guide channel for receiving said buck arm frame assembly;
a plurality of mounting clips joined to said mounting frame.

2. The livestock restraining device of claim 1 wherein:
said plurality of mounting clips comprises one or more mounting clips that are slidably attached to said mounting frame assembly via one or more guide brackets.

3. The livestock restraining device of claim 1 wherein: said first and second mounting frame members further comprise one or more detents or holes formed on a surface; said buck arm frame assembly further comprises one or more locking pins that slidably engage with one or more brackets fixedly attached to said buck arm frame assembly.

4. The livestock restraining device of claim 3 wherein: said locking pins moveably engage with said one or more detents or holes formed on a surface.

5. The livestock restraining device of claim 2 wherein: said plurality of mounting clips further comprise one or more springs disposed along a length of said mounting clips.

6. A livestock restraining device comprising:
a mounting frame assembly;
a buck arm assembly comprising a buck arm arrester, a quick release handle, and a plurality of quick release arms, said plurality of quick release arms being pivotally joined at a medial point and operatively joined to said buck arm arrester and said quick release handle, whereby applying a rotational force to said quick release handle causes said plurality of quick release arms to extend away from said buck arm assembly, thereby extending said buck arm arrester away from said mounting frame assembly.

7. The livestock restraining device of claim 6, wherein applying an opposite rotational force to said quick release handle causes said plurality of quick release arms to retract into said buck arm assembly, thereby retracting said buck arm arrester toward said mounting frame assembly.

8. The livestock restraining device of claim 6, wherein said buck arm arrester is rotationally joined to said buck arm assembly.

9. The livestock restraining device of claim 8, wherein said mounting frame assembly further comprises one or more guide channels for receiving said buck arm assembly.

10. The livestock restraining device of claim 9, wherein said mounting frame assembly further comprises one or more detents or holes formed on a surface of a first and second frame member, whereby a buck tube can traverse said one or more detents or holes to secure said buck arm assembly to said mounting frame assembly.

11. The livestock restraining device of claim 6, wherein said buck arm assembly further comprises a shroud for receiving a distal end of said buck arm arrester when said buck arm arrester is in a retracted position.

12. The livestock restraining device of claim 6, wherein said plurality of quick release arms when fully extended enter a locked position whereby said buck arm arrester in the extended position remains in a locked positioned.

13. A livestock restraining device for securing a livestock in a chute comprising:
a buck arm arrester;
a mounting frame assembly comprising a first mounting frame member, a second mounting frame member, and one or more cross members; and
a plurality of mounting clips, wherein one or more of said plurality of mounting clips are fixedly attached to said mounting frame assembly and wherein one or more of said plurality of mounting clips are slidably mounted to said mounting frame assembly.

14. The livestock restraining device of claim 13, wherein said one or more of said plurality of mounting clips that are slidably mounted to said mounting frame assembly further comprise a length whereupon one or more springs are disposed, said one or more springs engage one or more spring brackets thereby applying tension to said plurality of mounting clips that are slidably mounted to said mounting frame assembly.

15. The livestock restraining device of claim 13 further comprising:
a quick release handle;
a buck tube further comprising a detent or hole formed through or on a surface of said buck tube, wherein a distal end of said quick release handle engages with said detent or hole.

16. The livestock restraining device of claim 15, wherein said quick release handle further comprises a length whereupon one or more springs are disposed, said one or more springs engage one or more quick release spring brackets thereby applying tension to said quick release handle.

17. The livestock restraining device of claim 16, wherein said buck arm arrester is operatively joined to one or more springs to tension said buck arm arrester towards a retracted position.

18. The livestock restraining device of claim 17, wherein when said buck arm arrester is in an extended position disengagement of said distal end of said quick release handle from said detent or hole formed through or on a surface of said buck tube causes said springs operatively joined to said buck arm arrester to rotate said buck arm arrester toward a retracted position.

19. The livestock restraining device of claim 1 wherein said livestock restraining device is mounted to one or more tubular members of a chute.

20. The livestock restraining device of claim 13 wherein said livestock restraining device is mounted to one or more tubular members of a chute.
